(19) United States
(12) Patent Application Publication
(10) Pub. No.: US 2018/0299282 A1
(43) Pub. Date: Oct. 18, 2018

(54) MOBILE DEVICE APPLICATION THAT ENABLES EFFICIENT NAVIGATION TO URGENT CARE FACILITY BASED ON TRIAGE TIME AND INSURANCE

(71) Applicants: Kenton Cummins, Ogden, UT (US); Shane Garlick, Kaysville, UT (US); Ahlad Narakulla, Salt Lake City, UT (US)

(72) Inventors: Kenton Cummins, Ogden, UT (US); Shane Garlick, Kaysville, UT (US); Ahlad Narakulla, Salt Lake City, UT (US)

(21) Appl. No.: 15/954,525

(22) Filed: Apr. 16, 2018

Related U.S. Application Data
(60) Provisional application No. 62/485,699, filed on Apr. 14, 2017.

(51) Int. Cl. G01C 21/34; G01C 21/36; G06Q 40/08; H04W 4/024; H04W 4/20

(52) U.S. Cl. CPC G01C 21/3484; G01C 21/3697; H04W 4/20; H04W 4/024; G06Q 40/08

(57) ABSTRACT

A system and method for providing a mobile device application that may enable efficient navigation to urgent care facilities, wherein the navigation may be online or offline, wherein selection of the urgent care facility may depend on criteria that may include distance from current location, acceptance of the user's insurance and wait time at the urgent care facility.

### BACKGROUND OF THE INVENTION

### Field Of the Invention

This invention relates generally to mobile devices, navigation and healthcare. More specifically, the invention relates to enabling a user to locate and navigate to an urgent care facility, wherein the criteria for selecting an urgent care facility includes, but is not limited to, distance from current location, drive time from current location, acceptance of the user's insurance and wait time at the urgent care facility.

### Description of Related Art

Many people cannot identify all or some of the Urgent Care facilities where they live or work. Locating Urgent Care facilities becomes much harder to locate if you are vacationing, traveling or are in an unfamiliar area. Lacking this information, many people will simply locate the nearest hospital with an emergency room. The problem with using emergency rooms is that they may have much longer wait times and be more expensive to use.

Even if a person is familiar with Urgent Care facilities in an area, in an emergency, a user may not know which is closest, which is closer based on driving time, or which one may accept their insurance. Finally, the time that a person will have to wait before being seen by a doctor may vary widely depending on how busy an Urgent Care facility is, the number of doctors seeing patients, etc.

It would therefore be an advantage over the prior art to provide all of these functions in a single application that may be run on a user's mobile device.

### BRIEF SUMMARY OF THE INVENTION

In a first embodiment, the present invention is a system and method for providing a mobile device application that may enable efficient navigation to Urgent Care facilities, wherein selection of the urgent care facility may depend on criteria that may include distance from current location, driving time from current location, acceptance of the user's insurance and wait time at the Urgent Care facility.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is an illustration of the major components of the system.

FIG. 2 is view of the screen of a mobile device that is running the Mobile Application and display a list of Urgent Care Facilities that are ranked in order of triage time.

FIG. 3 is a chart showing a workflow process of the Mobile Application as it relates to the Backend Server and the Urgent Care Applet.

FIG. 4 is a chart showing a workflow process of the Urgent Care Applet as it relates to the Mobile Application and the Backend Server.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention and should not be viewed as narrowing the claims which follow.

A first embodiment of the present invention is directed toward solving a problem that is not presently addressed by any product or service today. Specifically, people (hereinafter to be referred to as a “user”) who need to go to an Urgent Care facility are faced with several problems. These include, but should not be considered as limited to, locating the urgent care facilities that are reachable within a reasonable amount of time, finding an urgent care facility that will accept the user's insurance, finding an urgent care facility that will enable the user to be seen by staff within a reasonable amount of time, being able to quickly navigate to the urgent facility that is selected and providing all of these functions on a mobile device within a single application that performs all of the functions above in an efficient manner.

Some of the functions above may be provided by existing standalone mobile device applications such as a map program for navigating to an urgent care facility, but it is the ability to provide all of these functions in one application that may be an advantage over existing systems.

The first embodiment of the invention may be an application on a mobile device. The mobile device may be selected from the group that includes mobile smartphones, tablets, car information systems, etc. The mobile devices may or may not have access to data networks such as the Internet or cellular networks. Accordingly, the application may be stored on the mobile device and may include a database of all needed information if the device is not connected to a data network, or the information may be accessed on a data network while the application is in use, or a combination of these functions. Furthermore, the application may be capable of executing on a public domain operating system or on a proprietary operating system such as Apple OS, Google Android, etc.

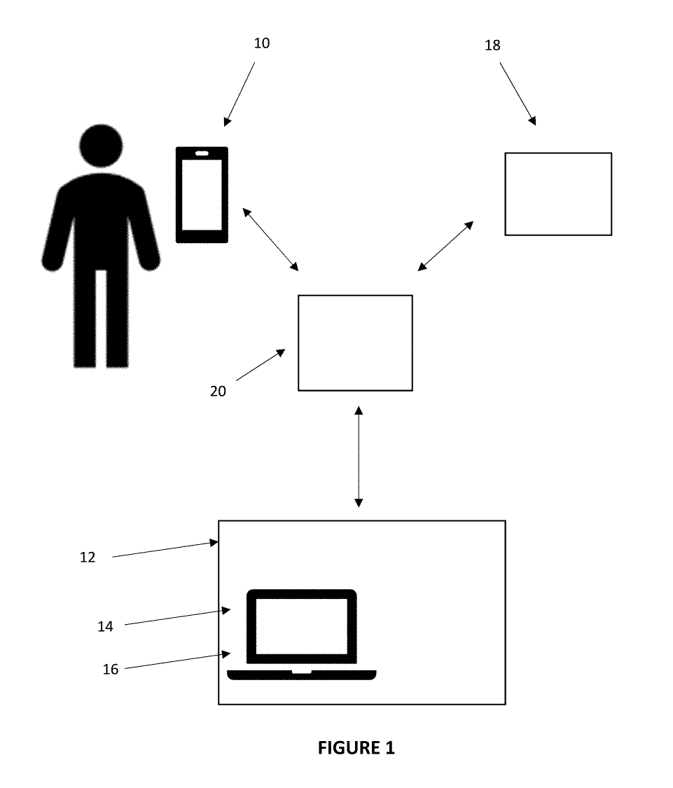

In a first embodiment of the invention as shown in FIG. 1, the invention may be comprised of a Mobile Application 10 running on a mobile device, an Urgent Care facility 12 running an Urgent Care Web Application 14 on a workstation, and a Wait Time Program 16, such as an Applet or any other small software program that is dedicated to collecting wait time information at each Urgent Care facility that provides wait time information to the mobile application. All these programs, i.e. the Mobile Application 10, the Urgent Care Web Application 14 and the Wait Time Program 16 (hereinafter referred to as the Urgent Care Applet 16), may all communicate with a Backend Server 18 via one or more communication networks 20.

The communication networks 20 may be cellular service, the Internet or a combination of these networks. Access to the communication networks 20 may be wired or wireless, and the different communication networks may communicate with each other to make communication seamless to all the programs.

The Mobile Application 10 may be downloaded onto the user's mobile device, and the Urgent Care facility will have both the Urgent Care Web Application 14 and the Urgent Care Applet 16 loaded onto a single workstation at the Urgent Care facility 12, preferably an intake desk. The Urgent Care Applet 16 may provide information to the Urgent Care Web Application 14 regarding wait times. Functions of the different programs will be described in more detail below.

To utilize the system, a user may first create a user profile on the Mobile Application 10 which may include a name, an insurance plan and possibly other information that may be useful for the Urgent Care facility 12 to receive. Other useful information may include but should not be considered as limited to age, sex, medications to which the patient is allergic, pre-existing medical conditions, etc. The Urgent Care facility may also create an Urgent Care facility profile which may include all insurance plans they accept, hours of operation, address, and possibly other information.

The user may initiate the Mobile Application 10 on their mobile device. The Mobile Application 10 may display a splash screen while Urgent Care Facility data 22 is loaded onto the mobile device via one of the communication networks 20. The Urgent Care Facility data 20 may include current wait times and any other information that may be useful, such as insurance providers that are accepted.

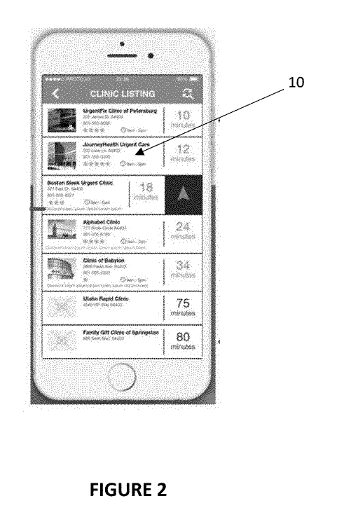

FIG. 2 is an illustration of a mobile device 10. Once loaded, the Mobile Application 10 may display any number of Urgent Care Facilities 12. The Urgent Care Facilities 12 may typically be listed in a manner that is convenient to the user. Because the Mobile Application 10 may be used in an emergency, the Urgent Care Facilities 12 may be listed in order of triage time. Triage time may be defined as driving time from the current location of the mobile device plus the wait time at an Urgent Care Facility 12.

FIG. 2 shows a total of seven Urgent Care Facilities 12 that are listed in order of triage time. This list is an example only and should not be considered as limiting of the embodiments of the invention. The user may scroll down through the list to see additional urgent care facilities.

The Urgent Care Facilities 12 may be tapped by a user, or a user may slide them to access more information, to select them, etc. The information that is displayed may include the triage time, the name of the Urgent Care Facility, hours of operation, an address, a rating, an indication if the user's insurance is accepted, or any other information that a user may want to see.

The system may include Urgent Care Facilities that are providing wait time information to the system (as part of a “Localis Network”), or they may not. If they are Localis Network Urgent Care Facilities, that may also be indicated on the list of Urgent Care Facilities. If the Urgent Care Facility 12 is not subscribed to the Localis Network by providing dynamic wait times, then a generic local or national average emergency room wait time may be provided. However, priority in the list may be provided to Localis Network Urgent Care Facilities because the wait times may be more accurate.

The user of the Mobile Application 10 may then select from the list the Urgent Care Facility 12 that they wish to visit by touching or swiping that particular Urgent Care Facility on the list. Once selected, the mobile device will change to a map, which may be the mobile device's default map program, showing the location of the Urgent Care Facility 12 and a route from the user's present location (location of the mobile device) to the Urgent Care Facility. The user may then drive to the Urgent Care Facility 12 using the map's routing capability.

One aspect of the first embodiment is that when the user selects an Urgent Care Facility 12 to visit, the Mobile Application 10 may transmit a current user profile to the Urgent Care Facility. The user may select the profile to send from a list so that the correct patient information is being sent. Thus, the user of the Mobile Application 10 may not be the patient being transported to the Urgent Care Facility 12. In this way, the Urgent Care Facility may be aware of pre-existing medication allergies or medical conditions of the patient. The Urgent Care Facility 12 may also be transmitted a picture of the patient and the predicted time of arrival by the Mobile Application 10.

The functions above describe the use and function of the Mobile Application 10. The next aspect of the first embodiment is the operation of the Urgent Care Applet 16 at the urgent Care Facilities 12. If the Urgent Care Facility 12 is part of the Localis Network, the Urgent Care Applet 16 is installed and run on a single workstation.

The Urgent Care Applet 16 may display several items. A first item may be a button that may state “Add Patient” and be colored green. A second item may be a button that may state “Minus Patient” and be colored red. A third item may be a status line showing a current wait time in minutes, and the number of patients who are waiting to see a care giver. IT should be understood that the wording on the buttons is not limiting of the embodiments of the invention or the claims, and that the wording may be eliminated or replaced with a symbol or other wording without changing the scope of the invention.

When a patient enters the Urgent Care Facility 12, a worker at the workstation may press the “Add Patient” button. As a person leaves the waiting room, the worker may press the “Minus Patient” button. A person may leave the waiting room by going back to see a care giver or may leave without seeing a care giver. What is important is that the person is no longer waiting and may be eliminated from the queue.

Whether adding a patient is initiated using the Urgent Care Applet 16 or using the Urgent Care Facility's 12 intake process, the “Minus Patient” button should be used when the patient sees a care giver or leaves the waiting room because they no longer are seeking care.

The system may maintain an estimated count of the patients currently waiting for care. For every “Add Patient” button click, a patient count is increased by one. For every “Minus Patient” button click, the patient count is reduced by one. The current patient count should be maintained in a database and be retrievable by the system, including the Urgent Care Applet 16 and the Urgent Care Web Application 14 Dashboard.

A line may be displayed on the Urgent Care Applet 16 that states “Current Patient Count Is: X”, where X equals the number of patients currently waiting to see a caregiver that is current stored in the system. This patient count should be updated in real time from the system.

When a user selects an Urgent Care Facility 12 on the Mobile Application 10 and begins traveling to that Urgent Care Facility, the patient's name and picture, if available, may be sent to the workstation of the Urgent Care Facility. Other information may also be sent including such things as the medical history of the patient, age, weight, sex, etc. What is probably most important is all the information that is typically requested by an Urgent Care Facility 12 when checking in may be provided to thereby decrease a wait time for the patient.

A display segment may be added to the top of the Urgent Care Applet 16 that states “Mobile Application Patient is on their way. Estimated time of arrival, X min”, where the Mobile Application Patient is the name of the patient whose profile may be selected in the Mobile Application 10.

Where possible, the Urgent Care Applet 16 may be replaced with the ability of the system to interface with an Urgent Care Facility's 12 intake application. This means that the depression of the “Add Patient” button may be replaced with the initiation of an intake application via some Patient intake process. The “Add Patient” time may be derived from when the intake application is opened, and the collection of information begins.

If the mobile application patient has not provided profile information, the verbiage on the Urgent Care Applet 16 may be “A Localis user is on their way. Estimated time of arrival, X min”, where X is the estimated drive time per the Mobile Application 10.

If one or more patients remain in a patient count for more than a certain period of time without any activity taking place with the “Add Patient” or “Minus Patient” buttons, a warning may appear to the worker at the workstation of the Urgent Care Facility 12 indicating that “A number of patients remain in the waiting count” with two dialog box options available to the worker, “Clear the Count” or “Keep the Count”.

If the worker selects “Clear the Count”, the “Minus Patient” button may be used to clear each remaining “Add Patient” selection until there are no more patients in the patient count. The current time will be used to determine the wait time for each “Minus Patient” scenario and the average wait times will be updated using that information. However, If the worker selects “Keep the Count”, the Urgent Care Applet 16 may return to its state of tracking the current patient count.

If the Urgent Care Applet 16 is closed and information remains in the patient count, all information will be zeroed out and all averages will be calculated based on this new information. There may be a dialog box that appears when a worker tries to close the Urgent Care Applet 16 in order to prevent accidental loss of patent count information. For example, a dialog box may ask if the worker wants to delete the current patient count.

It should be understood that the “Add Patient” and “Minus Patient” button depressions may not be associated with any specific patient or person. The system may use a FIFO (first in, first out) approach. After one or more clicks of the “Add Patient” button, when the “Minus Patient” button is clicked the time associated with the “Minus Patient” button click will be compared to the time of the oldest “Add Patient” button click and a difference in the times will be calculated and stored as a wait time.

As wait times are calculated, the average wait time throughout the day may be calculated and made available to be used throughout the system, including the Mobile Application 10 and the Urgent Care Web Application 14 Dashboard. At the beginning of each day the daily average may be reset to zero and updated throughout the day as information is collected through the Urgent Care Applet 16.

Within the system, a monthly and an annual wait time average may also be maintained. At the beginning of each calendar month, the average wait time for the month just completed may be stored for that month and the monthly average wait time will restart. At the beginning of each calendar year, the average wait time for the year just completed may be stored for that year and the annual average wait time will restart. At any given time, the daily, monthly and annual average wait times may be retrieved and used within the system, including the Urgent Care Web Application 14 Dashboard.

The system may maintain a daily count of visits to each Urgent Care Facility 12, utilizing the number of times the “Add Patient” button was clicked throughout the day. This count may be maintained in a database and will be retrievable by the system, including the Urgent Care Web Application 14 Dashboard.

It is another aspect of the first embodiment that some aspects of the Urgent Care Applet 16 may be automated to reduce human error from the system. For example, instead of a person having to press the “Add Patient” button on the Urgent Care Applet 16, the Urgent Care Facility 12 may have an electronic tablet that all patients use to sign in. The electronic tablet may remotely activate the “Add Patient” button of the Urgent Care Applet 16 when a patient enters data when checking in to the Urgent Care Facility 12.

It may be more difficult to automate the “Minus Patient” function when a potential patient may leave the Urgent Care Facility 12 before seeing a care giver, but it may be done and also automatically update the Urgent Care Applet 16.

The Urgent Care Web Application 14 or the Urgent Care Applet 16 may track the time between selection of the “Add Patient” button and the selection of the “Minus Patient” button in order to determine a current wait time. The current wait time may also be transmitted by the Urgent Care Web Application 14 or the Urgent Care Applet 16 to the Backend Server 18 so that current wait times are always up-to-date when transmitted to any user of the Mobile Application 10.

It is an aspect of the first embodiment that other data may be collected from use of the Urgent Care Applet 16 and displayed or transmitted by the Urgent Care Web Application 14. The other data may include but should not be considered as limited to:
Number of times the Mobile Application 10 has been downloaded in a particular geographic location
Number of times that a particular Urgent Care Facility was selected on the Mobile Application 10
Number of times the Mobile Application 10 was used to find an Urgent Care Facility 12
Current wait-times for an Urgent Care Facility 12
Average daily wait times for an Urgent Care Facility 12
Average turn-around times (time between a “Minus Patient” button press and another “Minus Patient” button press
Average patient inflow (time between a “Plus Patient” button press depression and another “Plus Patient” button press)
Patient Feedback (in prose and Star-rankings)
Analytic comparisons between specific Urgent Care facilities 12, and regional, and national Urgent Care Facilities.
The Number of Urgent Care Facilities that are part of the Localis Network versus those that are not in a particular geographic location.

The data that is collected may be available to the mobile application user, to the Urgent Care Facilities, or both. The data may also be used to create reports and charts available to the Urgent Care Facility 12 or an Administrator of the system.

A Command Center Web Application may also be provided to enable the Administrator of the system to maintain it. The Administrator may be able to:
List, with filtering capabilities, all Localis Network Urgent Care Facilities 12
List, with filtering capabilities, all out-of-Localis-network Urgent Care Facilities 12
The profile of all Urgent Care Facilities 12, including signed contracts, contract period, and payment details.
List all in-network Urgent Care Facilities 12 whose contract is about to run out.
Show analytics, such as
   High, low and average wait times for a particular geographic location.
   Number of Mobile Application 10 downloads for a particular geographic location.

The Urgent Care Facility 12 will also use the Urgent Care Web Application 14. The Urgent Care Facility 12 may be able to open the Urgent Care Web Application 14 to update a profile, specify unique information, view forums, download updates, and view and compare personal analytics and national analytics.

The Urgent Care Web Application 14 may also include a Dashboard for controlling the display and entry of information. A first entry on the Dashboard may be for General Profile Information which may include a profile picture, location (address), and hours of operation.

A second component of the Dashboard may be to select which insurance the Urgent Care Facility 12 accepts. A drop-down box of Insurance Providers (based on Address/Location) may be provided for selection.

A third component of the Dashboard may be the ability to get feedback about their performance from patients. The performance metrics may be selected (via dropdown box) or populated (typed). These performance metrics may include a 5-star rating standard and an “overall rating”.

A fourth component of the Dashboard may be the operation of one or more forums. Forums may include topic headers in which users of an Urgent Care Facility 12 may converse with other Urgent Care Facility managers/owners.

A fifth component of the dashboard may be to perform updates of the Urgent Care Web Application 14.

A sixth component of the dashboard may be for Analytics, including personal analytics and comparison analytics. The personal Analytics may include the following information:
The number of times the Mobile Application 10 has been downloaded in their geographic region.
Number of times their Urgent Care Facility was swiped on the mobile application this month.
Number of times the Mobile Application 10 was used to find an Urgent Care Facility 12 this month.
Current wait-times for Urgent Care Facilities 12.
Graph of daily wait times over prior 30 days.
Average turn-around times (time between a “Minus Patient” button depression and another “Minus Patient” button depression.)
Average patient inflow (time between an “Add Patient” button depression and another “Add Patient” button depression.)
Average stars given on Feedback on Mobile Application 10 by patients.
These objective metrics may be used to calculate an overall score out of 10 and give actionable suggestions for betterment of score.

In contrast, regional and national Analytics may include analytics are for comparison purposes. These analytics may include an average of the personal metrics above of regional numbers, and national numbers. Regional ranges may either be selection via drop down box (i.e. 25, 50, 100 miles, and national #'s) or can be automated.

It is useful to examine the workflow of the mobile application in order to understand the overall operation of the system.

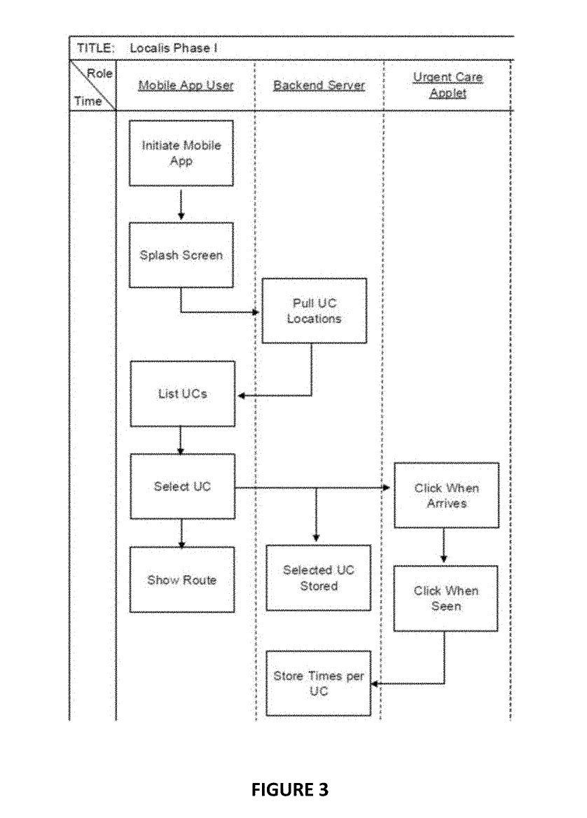

FIG. 3 is provided as an illustration of the workflow process of the Mobile Application 10 as it relates to the Backend Server 18 and the Urgent Care Applet 16.

The process begins when the Mobile Application 10 User initiates the Mobile Application on the mobile device. A splash screen may be displayed. The Mobile Application 10 then requests the most current data regarding wait times from the Backend Server 18. This data is transmitted from the Backend Server 18 to the Mobile Application 10. The Mobile Application then displays a list of Urgent Care Facilities 12, listed in order of triage time. The user may select an Urgent Care Facility 12. At this time, the user may also have the option of selecting a patient profile to be transmitted to the Urgent Care Facility. The mobile Application 10 then shows a route from the current location to the Urgent Care Facility 12 that was selected.

Right after the Urgent Care Facility 12 is selected, this information is transmitted via the communication networks 20 to the Backend Server 18. This information may also be transmitted to the Urgent Care Applet 16 so that the estimated arrival time of the patient may be displayed by the Urgent Care Applet.

When the patient arrives at the Urgent Care Facility 12, a worker at the workstation running the Urgent Care Applet 16 click on the “Add Patient” button. As soon as the patient is directed into an examination room or some other location other than the waiting room or leaves the Urgent Care Facility 12 without being seen, the worker then clicks on the “Minus Patient” button. Information regarding when the “Add Patient” button and “Minus Patient” button were clicked on may be transmitted to the Backend Server 18 by the Urgent Care Applet 16 in order to generate wait times, average turn-around times, average patient inflow, and any other useful analytics that can be generated from the data.

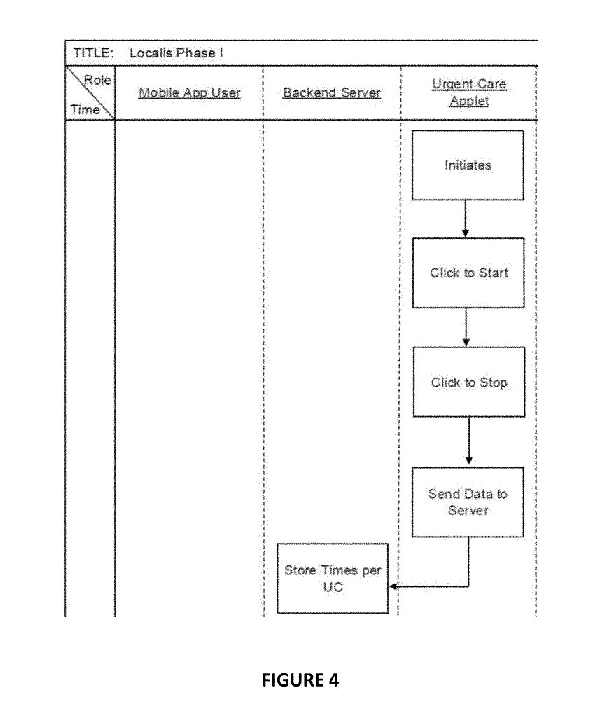

FIG. 4 is provided as an illustration of the workflow process of the Urgent Care Applet 16 as it relates to the Mobile Application 10 and the Backend Server 18.

The Urgent Care Applet 16 is initiated on the workstation at the Urgent Care Facility 12. The Urgent Care Applet 16 may be installed so that it starts automatically when the workstation is booted up or it may be started manually. The worker operating the Urgent Care Applet 16 will click on the “Add Patient” button when a patient enters the facility. This process may be automated using a tablet or other electronic device that determines that a patient is providing patient information or checking in at a front desk or with a receptionist.

The worker operating the Urgent Care Applet 16 will click on the “Minus Patient” button when a patient leaves the waiting room. The patient may leave the waiting room by being called further into the Urgent Care Facility 12 or exiting the waiting room to leave the Urgent Care Facility. This process may be harder to automate but may be done.

Anytime that a button on the Urgent Care Applet 16 is clicked, that information is transmitted to the Backend Server 18 where the times are recorded in order to determine the analytics of the system such as wait times.

The Backend Server 18 may do more than record button clicks of the Urgent Care Applet 16, transmit Urgent Care Facility 12 wait times to the Mobile Application 10, and store Urgent Care facility selections. The Backend Server 18 may also maintain a list of all insurance plans available by the different insurance companies. This does not just include the insurance companies, such as Blue Cross and SelectHealth, but each plan that the insurance companies provide. The state where the insurance plans are offered will also be associated with each plan.

The backend server may also maintain the profile of each individual Urgent Care Facility 12 and be able to associate each profile with its associated Urgent Care Facility.

The Backend Server 18 may also be used to calculate drive times. Most, if not all, mobile map applications provide times needed to reach a selected location. They can provide either drive time and/or walk time. The Mobile Application 10 may need to search the system database on the Backend Server 18 located at the hosting site and determine the drive time for the Urgent Care Facilities that are closest to the patient.

The Backend Server 18 may also be used to store feedback received from users of the Mobile Application 10. The user of the Mobile Application 10, after leaving the Urgent Care Facility, may be notified to leave feedback regarding service. There should only be a few questions with star-ratings below them for quick feedback. A few of the Feedback Questions may be manipulated by the Urgent Care Facility via the Urgent Care Web Application 14 Dashboard.

For example, questions such as, “Front Desk Service, Clinical Service, Cleanliness, Which Dr. Served You Today? Tell us how we did today?”. . . may be found on the Feedback page (drop-down box or fill in box on the Urgent Care Web Application 14 Dashboard).

Some questions may be optional while others may not be. For example, “Wait-time accuracy and Overall Rating” may not be optional ratings.

Once the Feedback page is completed, the Mobile Application may thank the user for their feedback.

The system may be offered on a trial basis for a set period of time. Once the trial period has ended, the user may be automatically charged a periodic service fee.

In another aspect of the first embodiment of the invention, it should also be understood that billing for use of the system may also be accomplished. The system must be able to obtain Urgent Care Facility credit card information and use that information to bill the Facility. The billing may be done automatically and at a predetermined time unless the Urgent Care Facility decides to cancel the service. Date of cancellation may be maintained in the system. When the Urgent Care Facility 12 cancels the service, no refund will be provided, but the Urgent Care Facility 12 may be able to use the service through the end of their paid period.

The first embodiment of the invention is directed toward a mobile application 10 that lists Urgent Care Facilities 12 by triage time, which is the sum of driving time to the Urgent Care Facility and wait time before being seen by a care giver. If the Urgent Care Facility 12 is not part of the Localis Network, then national or regional or local wait time averages may be used.

In an alternative embodiment of the invention, the mobile application 10 may consider other parameters in order to list the Urgent Care Facilities 12. For example, in a second embodiment of the invention, the list may only show those Urgent Care Facilities 12 that are known to accept the patient's insurance. Alternatively, all Urgent Care Facilities 12 may be listed, but the ones at the top of the list are known to accept the patient's insurance.

It should be understood that one of the advantages of all of the embodiments of the invention is that the system is provided for any user regardless of the type of the insurance that they use or whether or not they have a particular employer. Even a self-insured person may take advantage of the embodiments of the invention.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A method for enabling a user to minimize the time to reach an urgent care facility by using a mobile application, said method comprising:
providing a mobile device running a mobile application, and providing a backend server;
storing a database of urgent care facilities on the backend server, wherein the database includes at least a location of the urgent care facilities and an associated wait time for patients to see a care giver at each of the urgent care facilities;
determining a location of the mobile device;
determining a triage time for each of a plurality of urgent care facilities for a user of the mobile device, wherein the triage time is a sum of driving time from the location of the mobile device to each of the plurality of urgent care facilities, plus the associated wait time at each of the plurality of urgent care facilities;
downloading the triage time for each of the plurality of urgent care facilities to the mobile application on the mobile device;
listing the plurality of urgent care facilities based on the triage time;
selecting one of the plurality of urgent care facilities by using the mobile application;
displaying a map on the mobile device showing a route from the location of the mobile device to the selected urgent care facility; and
driving from the location of the mobile device to the selected urgent care facility.

2. The method as defined in claim 1 wherein the method further comprises:
creating at least one patient profile in the mobile application;
selecting at least one patient profile in the mobile application; and
transmitting the at least one patient profile from the mobile application to the selected urgent care facility.

3. The method as defined in claim 2 wherein the method further comprises:
storing a list of insurance companies that are accepted by each of the plurality of urgent care facilities in the database on the backend server;
downloading the list of insurance companies associated with the plurality of urgent care facilities to the mobile application when the triage times are downloaded; and
including the list of insurance companies associated with each of the plurality of urgent care facilities when they are listed by triage time.

4. The method as defined in claim 3 wherein the method further comprises:
comparing the list of insurance companies to any insurance company listed in the at least one patient profile to identify all of the plurality of urgent care facilities that also use any insurance company listed in the at least one patient profile; and
listing the plurality of urgent care facilities by the triage time and placing all of the plurality of urgent care facilities that use any insurance company listed in the at least one patient profile above those urgent care facilities that do not use any of the insurance companies in the at least one patient profile.

5. The method as define in claim 5 wherein the method further comprises including insurance plans of the insurance companies in the database on the Backend Server so that the patient may also determine if a specific insurance plan is accepted by the plurality of urgent care facilities.

6. The method as defined in claim 1 wherein the method further comprises:
providing an urgent care applet on a workstation at each of the plurality of urgent care facilities that want to provide dynamic wait times to the mobile application;
providing a first button on the urgent care applet that enables a patient count to be increased by one;
providing a second button on the urgent care applet that enables the patient count to be decreased by one;
clicking on the first button when a patient enters the urgent care facility and clicking on the second button when the patient leaves the waiting room; and
transmitting data to the database on the Backend Server regarding which of the first and second buttons is clicked and when the first and second buttons are clicked.

7. The method as defined in claim 6 wherein the method further comprises displaying a patient name and an estimated time of arrival of a patient using the mobile application when the patient sends a patient profile to the urgent care facility.

8. The method as defined in claim 6 wherein the method further comprises:
providing an urgent care web application on the workstation at each of the plurality of urgent care facilities, wherein the urgent care web application provides an interface to the database on the Backend Server and to the mobile application; and
displaying data from the database, wherein the data may be selected from the group of data comprised of: the number of times the mobile application has been downloaded in a particular geographic location, the number of times that a particular urgent care facility was selected on the mobile application, the number of times the mobile application was used to find an urgent care facility, current wait-times for an urgent care facility, average daily wait times for an urgent care facility, average turn-around times, average patient inflow patient feedback (in prose and star-rankings), analytic comparisons between specific urgent care facilities, and regional, and national urgent care facilities, and the number of urgent care facilities that are part of a network using the mobile application versus those that are not in a particular geographic location.

9. The method as defined in claim 6 wherein the method further comprises displaying data from the database, wherein the data may be selected from the group of data comprised of:

10. The method as defined in claim 8 wherein the method further comprises:
providing a command center web application that enables an administrator to maintain the database on the backend server;
displaying data from the database wherein the data may be selected from the group of data comprised of: a listing of all Localis network urgent care facilities, a listing of all out-of-Localis-network urgent care facilities, a profile of all urgent care facilities including signed contracts, contract period, and payment details, a listing of all in-network urgent care facilities whose contract is about to run out, a listing of analytics, such as high, low and average wait times for a particular geographic location, and the number of mobile application downloads for a particular geographic location.

11. The method as defined in claim 7 wherein the method further comprises: the number of times the mobile application has been downloaded in their geographic region, the number of times their urgent care facility was swiped on the mobile application in a current month, the number of times the mobile application was used to find an urgent care facility in a current month, the current wait-times for urgent care facilities, a graph of daily wait times over prior 30 days, the average turn-around times, the average patient inflow, and the average stars given on feedback on mobile application by patients.

12. A system for determining an optimal location of a care giver relative to a current location of a mobile device, said system comprised of:
a mobile device running a mobile application;
a backend server;
a database of urgent care facilities stored on the backend server, wherein the database includes at least a location of the urgent care facilities and an associated wait time for patients to see a care giver at each of the urgent care facilities;
a first processor for determining a location of the mobile device;
a second processor for determining a triage time for each of a plurality of urgent care facilities for a user of the mobile device, wherein the triage time is a sum of driving time from the location of the mobile device to each of the plurality of urgent care facilities, plus the associated wait time at each of the plurality of urgent care facilities;
a network connection for downloading the triage time for each of the plurality of urgent care facilities to the mobile application on the mobile device;
a display on the mobile device for listing the plurality of urgent care facilities based on the triage time and for selecting one of the plurality of urgent care facilities by using the mobile application; and
a map application on the mobile device for showing a route from the location of the mobile device to the selected urgent care facility.

13. A method for enabling a user to determine which urgent care facility to go to relative to driving time and wait time by using a mobile application, said method comprising:
providing a mobile device running a mobile application, and providing a backend server;
storing a database of urgent care facilities on the backend server, wherein the database includes at least a location of the urgent care facilities and an associated wait time for patients to see a care giver at each of the urgent care facilities;
determining a location of the mobile device;
determining a triage time for each of a plurality of urgent care facilities for a user of the mobile device, wherein the triage time is a sum of driving time from the location of the mobile device to each of the plurality of urgent care facilities, plus the associated wait time at each of the plurality of urgent care facilities;
downloading the triage time for each of the plurality of urgent care facilities to the mobile application on the mobile device; and
listing the plurality of urgent care facilities based on the triage time.

14. The method as defined in claim 13 wherein the method further comprises:
selecting one of the plurality of urgent care facilities by using the mobile application;
displaying a map on the mobile device showing a route from the location of the mobile device to the selected urgent care facility; and
driving from the location of the mobile device to the selected urgent care facility.

15. The method as defined in claim 14 wherein the method further comprises:
creating at least one patient profile in the mobile application;
selecting at least one patient profile in the mobile application; and
transmitting the at least one patient profile from the mobile application to the selected urgent care facility.

16. The method as defined in claim 15 wherein the method further comprises:
storing a list of insurance companies that are accepted by each of the plurality of urgent care facilities in the database on the backend server;
downloading the list of insurance companies associated with the plurality of urgent care facilities to the mobile application when the triage times are downloaded; and
including the list of insurance companies associated with each of the plurality of urgent care facilities when they are listed by triage time.

17. The method as defined in claim 16 wherein the method further comprises:
comparing the list of insurance companies to any insurance company listed in the at least one patient profile to identify all of the plurality of urgent care facilities that also use any insurance company listed in the at least one patient profile; and
listing the plurality of urgent care facilities by the triage time and placing all of the plurality of urgent care facilities that use any insurance company listed in the at least one patient profile above those urgent care facilities that do not use any of the insurance companies in the at least one patient profile.

18. The method as define in claim 17 wherein the method further comprises including insurance plans of the insurance companies in the database on the Backend Server so that the patient may also determine if a specific insurance plan is accepted by the plurality of urgent care facilities.

19. The method as defined in claim 18 wherein the method further comprises:
providing an urgent care applet on a workstation at each of the plurality of urgent care facilities that want to provide dynamic wait times to the mobile application;
providing a first button on the urgent care applet that enables a patient count to be increased by one;
providing a second button on the urgent care applet that enables the patient count to be decreased by one;
clicking on the first button when a patient enters the urgent care facility and clicking on the second button when the patient leaves the waiting room; and
transmitting data to the database on the Backend Server regarding which of the first and second buttons is clicked and when the first and second buttons are clicked.

20. The method as defined in claim 19 wherein the method further comprises displaying a patient name and an estimated time of arrival of a patient using the mobile application when the patient sends a patient profile to the urgent care facility.
